(19) United States
(12) Patent Application Publication
(10) Pub. No.: US 2016/0321621 A1
(43) Pub. Date: Nov. 3, 2016

(54) SYSTEMS AND METHODS FOR DISTRIBUTING CHECKS AND PAYSTUB DATA USING AUTOMATED TELLER MACHINES

(71) Applicant: MASTERCARD INTERNATIONAL INCORPORATED, Purchase, NY (US)

(72) Inventors: Shekhar Sahgal, Stamford, CT (US); Ryan Bodman, Louisville, KY (US); Der Pei Wang, Scarsdale, NY (US); Beth Marie Griffin, Delafield, WI (US); Stephen Parento, White Plains, NY (US)

(73) Assignee: MASTERCARD INTERNATIONAL INCORPORATED, Purchase, NY (US)

(21) Appl. No.: 14/700,628

(22) Filed: Apr. 30, 2015

(51) Int. Cl. G06Q 20/04; G07F 19/00; G06Q 40/00; B41F 17/00; G06Q 20/10; G06Q 20/40

(52) U.S. Cl. CPC G06Q 20/042; G06Q 20/1085; G06Q 20/409; G06Q 40/125; B41F 17/00; G07F 19/203

(57) ABSTRACT

Systems and methods for producing checks and paystub information from an automated teller machine (“ATM”) are described. The ATM transmits either a check request or a paystub information request to a payment card network, which transmits the received request to a card issuer. In the case of a check request, the card issuer verifies sufficient funds within a cardholder account. In the case of a paystub information request, the card issuer transmits the request to an employer payroll computer, which transmits the requested paystub information back to the card issuer. The card issuer transmits the draft authorization or the paystub information to the payment card network. The ATM ultimately receives the draft authorization and thereby produces a check or money order, or receives the paystub information and thereby provides the cardholder with the information.

### FIELD OF TECHNOLOGY

The present disclosure relates generally to electronic communication of financial information and, more particularly, to automated teller machines and ATM networks with extended functionality of generating checks and payroll data from an automated teller machine.

### BACKGROUND

Generally, automated teller machines (“ATM”) are affiliated with banks or other financial institutions. Traditionally, each ATM is capable of communicating with the bank or financial institution affiliated with that particular ATM via one or more ATM networks. Moreover, ATMs are generally capable of performing only limited types of transactions, including cash deposits and withdrawals, and check deposits.

### SUMMARY

The present disclosure describes, in detail, systems and methods for generating checks, such as checks and money orders, and payroll data from an ATM capable of communicating with an entity other than an affiliated bank or financial institution.

An aspect of the present disclosure relates to a method for generating a check from an ATM comprising reading an ATM readable card to access an account of a user and receiving a check request, including a check amount, from the user. The method further comprises transmitting a debit order for the check amount to a payment card network that is coupled to a plurality of ATM readable card issuers. Additionally, the method comprises receiving a confirmation from the payment card network that the check amount was deducted from the account of the user in response to the debit order, and printing a check for the check amount.

The check of the aforementioned method is either a check or a money order. The check request may include entity information pertaining to an entity to receive the check. The method may further comprise determining whether the check amount equals an amount of the confirmation that was deducted from the account of the user. Moreover, neither the payment card network nor the plurality of ATM readable card issuers may own or operate the ATM.

Another aspect of the present disclosure relates to a method for distributing payroll data from an ATM comprising reading an ATM readable payroll card to access a payroll account of the user, and receiving a payroll data request from the user. The method further comprises transmitting the payroll data request to a payment card network that is coupled to a plurality of ATM readable payroll card issuer. Moreover, the method comprises receiving payroll data from the payment card network, and printing a receipt containing the payroll data.

The payroll data request may include a date upon which the payroll data became available to the user and the payroll data may include a least one of gross income, net income, or withholdings. Additionally, the method may comprise determining whether the data associated with the payroll data request equals a date of the payroll data received from the payment card network. Moreover, neither the payment card network nor the plurality of ATM readable payroll card issuers may own or operate the ATM.

Yet another aspect of the present disclosure relates to an ATM for generating a check or payroll data comprising a memory, at least one processor, and a persistent storage device that stores in a non-transitory manner instructions that cause the at least one processor to receive ATM readable card information and receive verification information from a user. The at least one processor further receives a check request or payroll data request from the user. Additionally, the processor transmits a debit order or the payroll data request to a payment card network that is coupled to a plurality of ATM readable card issuers. Moreover, the processor receives an account deduction conformation or requested payroll data, and provides the user with a check or payroll data.

The check request may include a check amount and information pertaining to an entity to receive the check. The check may be a check or money order. The ATM readable card may be a payroll card and the payroll data request may include a date upon which the payroll data became available to the user. Moreover, the payroll data may include gross income, net income, and withholdings. The processor may further determine whether an amount of the account deduction confirmation equals an amount of the check request. Additionally, the processor may determine whether a date affiliated with payroll data of the payroll data request equals a date affiliated with the requested payroll data. The verification information may include a personal identification number.

An additional aspect of the present disclosure relates to a method for performing an ATM transaction. The method includes an ATM reading an ATM card to access a user account. The method further includes the ATM sending a request to a payment card network, which is coupled to card issuers. The request includes a request to one of the card issuers for authorization of a check. The method further includes the ATM receiving the authorization for the check from the payment card network. Moreover, the an ATM transaction of producing a check, requested by the ATM user, is performed.

The method may further include sending the request for the check to an ATM operator. Additionally, the method may include the ATM receiving the authorization for the check from the ATM operator.

Another aspect of the present disclosure relates to a method for performing an ATM transaction. The method includes an ATM reading an ATM card to access a user account, and the ATM sending a request to a payment card network. The payment card network is coupled to card issuers, and the card issuers are coupled to employer payroll computers. The request includes a request to one of the employer payroll computers for paystub information. The method also includes the ATM receiving the paystub information from the payment card network. Moreover, the method includes performing an ATM transaction requested by a user wherein the ATM produces the paystub information.

Yet another aspect of the present disclosure relates to a system for performing an ATM transaction. The system includes an ATM operator coupled to an ATM, a payment card network coupled to the ATM operator, and an ATM card issuer coupled to the payment card network. The system also includes an employer payroll computer, including a processor and a data storage apparatus, coupled to the ATM card issuer. A paystub database is stored in the data storage apparatus. The paystub database contains paystub information specific to an ATM user. The ATM operator is configured to receive a paystub request from the ATM. The paystub request indicates a timeframe of requested paystub information. Moreover, the ATM operator receives the paystub information from the payment card network and determines whether the receives paystub information matches the timeframe of the paystub request. When the receives paystub information contains the correct timeframe, the ATM operator transmits the paystub information to the ATM.

The paystub request may include gross income, net income, and/or withholding amounts. The employer payroll computer may access the paystub database in response to receiving the paystub request from the ATM card issuer.

Another aspect of the present disclosure relates to a system for performing an ATM transaction. The system includes an ATM operator coupled to an ATM, a payment card network coupled to the ATM operator, and an ATM card issuer coupled to the payment card network. The ATM card issuer includes a processor and a data storage apparatus. An ATM account database, that contains account information specific to an ATM user, is stored in the data storage apparatus. Moreover, the ATM operator receives a check request, includes a check amount requested by the ATM user, from the ATM. The ATM operator also receives a draft authorization from the payment card network. The ATM operator further determines whether a draft authorization amount matches the amount of the check request. When the draft authorization amount is correct, the ATM operator transmits the draft authorization to the ATM.

The draft authorization may include a routing number and a bank account number when the user requests a check. Alternatively, the draft authorization may include a serial number when the user requests a money order.

Additional features and advantages of the present disclosure are described below. It should be appreciated by those skilled in the art that this disclosure may be readily utilized as a basis for modifying or designing other structures, systems and processes for carrying out the same purposes of the present disclosure. It should also be realized by those skilled in the art that such equivalent implementations do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The particular features and advantages of the present disclosure will be apparent from the detailed description set forth below in conjunction with the drawings in which like reference characters identify corresponding aspects throughout.

FIG. 1 is a conceptual block diagram illustrating a general system for generating checks and paystub data from an automated teller machine according to the present disclosure.

FIG. 2 is a system flow diagram detailing a method for providing a user/cardholder with a check or money order at an automated teller machine according to the present disclosure.

FIG. 3 is a system flow diagram detailing a method for providing a user/cardholder with paystub data at an automated teller machine according to the present disclosure.

FIG. 4 is a process flow diagram detailing a method for generating a check at an automated teller machine according to the present disclosure.

FIG. 5 is a process flow diagram detailing a method for generating paystub information at an automated teller machine according to the present disclosure.

FIG. 6 is a block diagram detailing a system for providing checks and payroll data from an automated teller machine according to the present disclosure.

### DETAILED DESCRIPTION OF EMBODIMENTS

The detailed description set forth herein makes reference to the accompanying drawings, which show various aspects of the present disclosure by way of illustration. While these various aspects are described in sufficient detail to enable those skilled in the art to practice the disclosure, it should be understood that other embodiments and implementations may be realized and that logical and mechanical changes may be made without departing from the scope of the disclosure. Thus, the detailed description herein is presented for purposes of illustration only and not of limitation. For example, the steps recited in any of the method or process descriptions may be executed in any order and are not limited to the order presented, unless specifically and explicitly indicated.

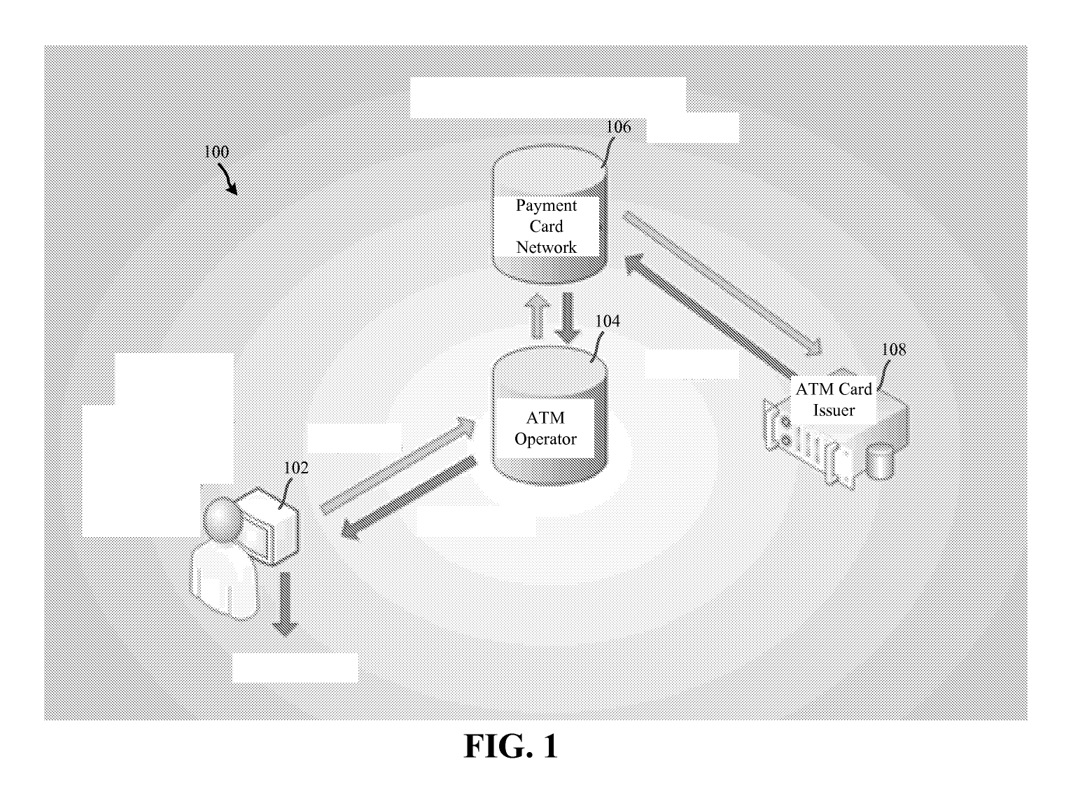

FIG. 1 provides a general overview of a system 100 for generating checks and payroll data from an automated teller machine (“ATM”). The system 100 includes an ATM 102, an ATM operator 104, a payment card network 106, and an ATM card issuer 108. The components 102, 104, 106, 108 of the system 100 may be in direct communication, or may be in indirect communication via one or more networks.

A user interacts with an interface of the ATM 104 to effect a variety of transactions using an ATM card. The variety of transactions capable of being engaged and performed include the generation of checks and payroll data. Checks as used herein may refer to negotiable instruments in general, thereby including checks and other documents such as money orders.

The ATM 102 exchanges various data/information, such as check requests and paystub requests, with the ATM operator 104. The ATM 104 also generate checks, other negotiable instruments such as money orders, and paystubs, for example.

The ATM operator 104 is in communication with the payment card network 106, which may be an entity that acts as a custodian and/or clearing house for payment cards affiliated with it, for example a card association. The presence of the payment card network 106 allows the ATM 102 to gain access to any ATM card issuer 108, rather than just the bank or financial institution that owns or operates the ATM 102.

The ATM card issuer 108 may be an entity, such as a bank or other financial institution, that issues ATM cards to users. Such ATM cards include, for example, credit/debit cards, debit cards, and various prepaid/preloaded cards, such as payroll cards (defined in detail below). The ATM cards issued by the ATM card issuer 108 may be affiliated with the payment card network 106. Both the payment card network 106 and the ATM card issuer 108 may be unaffiliated with the ATM 104. That is, the payment card network 106 and ATM card issuer 108 may not own or operate the ATM 104.

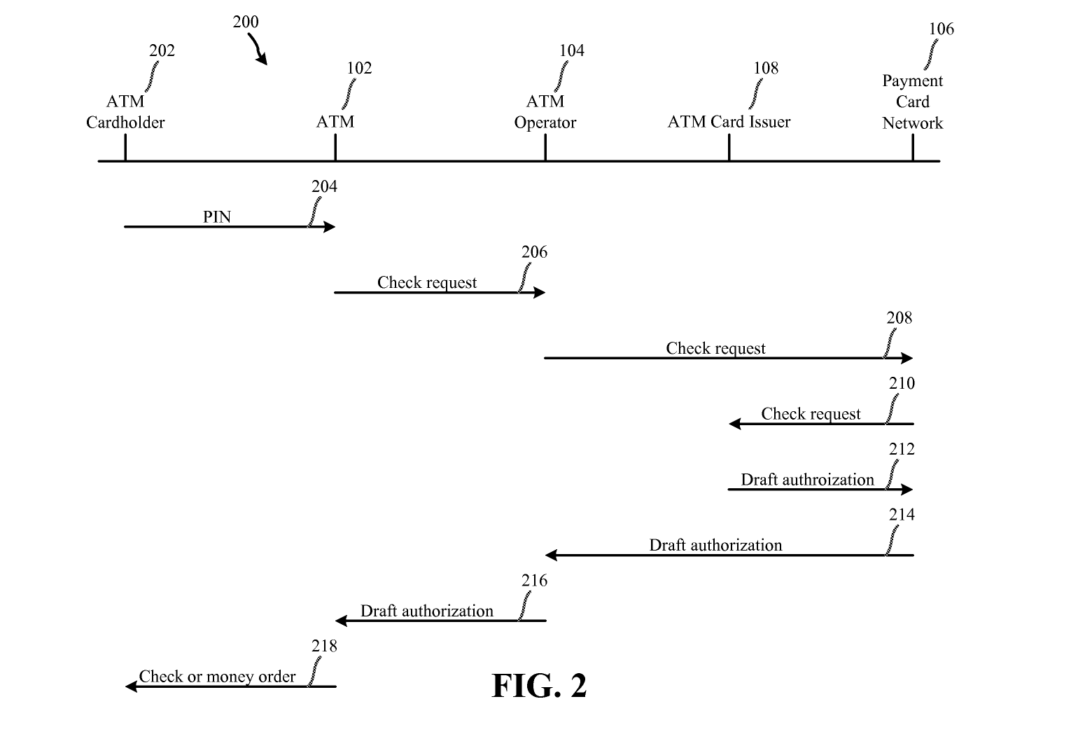

FIG. 2 illustrates a system 200 for providing a user with a check at an ATM. The system 200 includes an ATM cardholder 202, the ATM 102, the ATM operator 104, the payment card network 106, and the ATM card issuer 108.

The ATM cardholder 202 presents the ATM 102 with an ATM card and its corresponding personal identification number (“PIN”) (illustrated as 204). The ATM reads the presented ATM card to access a cardholder account. The presented ATM card may be, for example, a credit/debit card, debit card, or prepaid/preloaded card, such as a payroll card (defined in detail below). Additionally, the ATM 102 transmits a check request to the ATM operator 104 (illustrated as 206). The check request may include the entity to which a requested check or money order is to be conveyed, as well as the amount, in dollars or some other currency, of the check or money order. The check request may further include user/card identifying information received when the ATM 102 read the presented ATM card. The ATM operator 104 transmits the check request to the payment card network 106 (illustrated as 208). The payment card network 106 in turn transmits the check request to the ATM card issuer 108 (illustrated as 210).

The ATM card issuer 108 may determine, using an ATM card database including information pertaining to the transacted ATM card, whether an account affiliated with the ATM card has sufficient funds to back the requested check request. If the account has sufficient funds, the ATM card issuer 108 transmits a draft (i.e., check or money order) authorization to the payment card network 106 (illustrated as 212). In the case of a check, the draft authorization may include routing and account numbers. Further, the user account does not need to be debited upon receiving the check request but, rather, it may be debited upon the check being redeemed. In the case of a money order, the draft authorization may include a serial number specific to the money order. Further, the user account may be deducted immediately upon the draft authorization being produced for the money order.

The payment card network 106 transmits the draft authorization to the ATM operator 104 (illustrated as 214). The ATM operator 104 thereby transmits the draft authorization to the ATM 102 (illustrated as 216). Upon receiving the draft authorization, the ATM 102 produces the check or money with its corresponding routing and account numbers, or serial number, respectively (illustrated as 218).

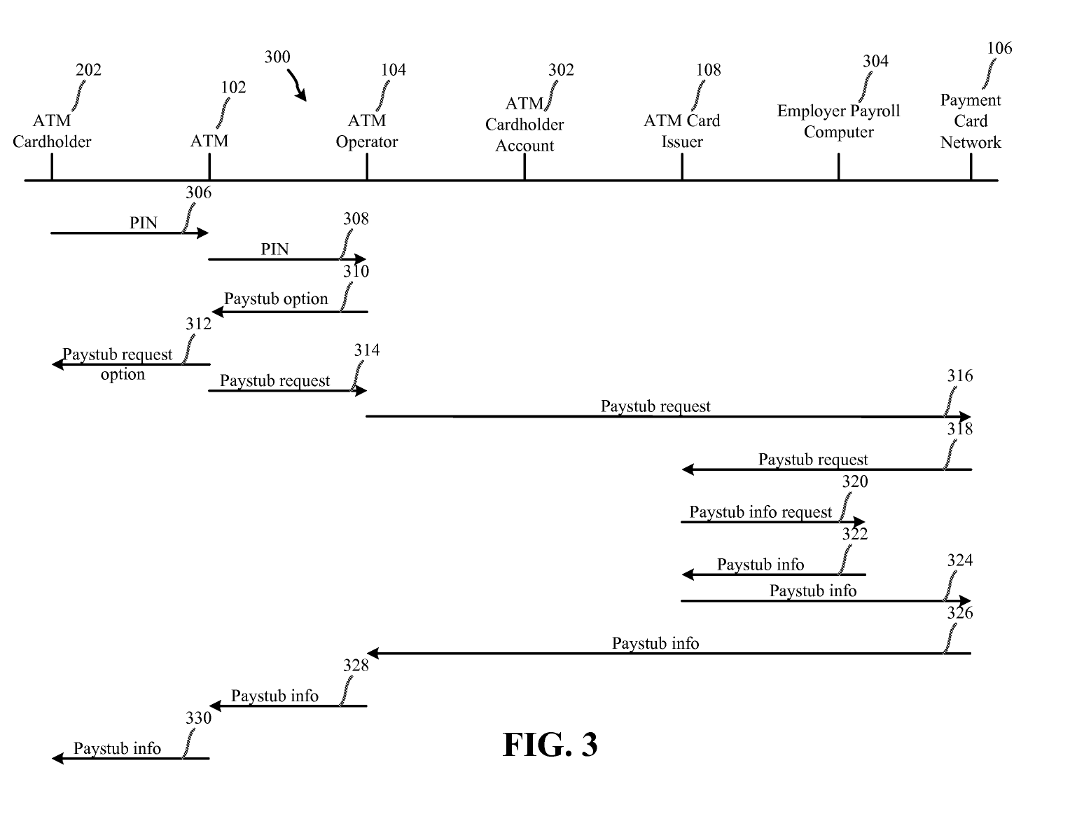

FIG. 3 illustrates a system 300 for providing a user with paystub information at an ATM. The system 300 includes the ATM cardholder 202, the ATM 102, the ATM operator 104, an ATM cardholder account 302, the ATM card issuer 108, an employer payroll computer 304, and the payment card network 106.

The ATM cardholder 202 presents the ATM 102 with an ATM card and its corresponding personal identification number (“PIN”) (illustrated as 306). The ATM reads the presented ATM card to access a cardholder account. The presented ATM card may be, for example, a payroll card. A payroll card is used by an employer as an alternative to producing payroll checks. The payroll card allows an employee's pay information to be posted to an account tied to the employee's payroll card. Once the employee's payroll information is loaded to their personal payroll account/card they can have immediate access to the funds, however, the employer is still required to provide the employee with a paystub detailing various employment information, such as gross income, net income, and withholding amounts, for example.

The ATM 102 transmits the PIN, and other cardholder identifying information, to the ATM operator 104 (illustrated as 308). The ATM operator 104, upon determining the presented ATM card is a payroll card, transmits an option for paystub information to the ATM 102 (illustrated as 310), and the ATM 102 transmits a paystub requested option to the ATM cardholder 202 (illustrated as 312). When the ATM cardholder 202 wants access to paystub information, the ATM 102 transmits a paystub request to the ATM operator 104 (illustrated as 314). The paystub request may include a time frame to which the paystub information pertains, or may include a specific date upon which the paystub data became available to the ATM cardholder 202. The ATM operator 104 transmits the paystub request to the payment card network 106 (illustrated as block 316). The payment card network 106 transmits the paystub request to the ATM card issuer 108 (illustrated as 318).

The ATM card issuer 108 transmits a paystub information request to the employer payroll computer 304 (illustrated as 320). In an implementation of the system 300, the ATM card issuer 108 is in direct communication with the employer payroll computer 304. The paystub information request may include a specific date or timeframe pertaining to the ATM cardholder 202 requested paystub information. The paystub information request may further include the type of paystub information requested, e.g., gross income, net income, and withholding amounts, The employer payroll computer 304 acquires, using a payroll information database, the requested paystub information affiliated with an account of the ATM cardholder's payroll card (not illustrated). The employer payroll computer 304 transmits the acquired paystub information to the ATM card issuer 108 (illustrated as 322), which in turn transmits the paystub information to the payment card network 106 (illustrated as 324). The paystub information transmitted to the ATM card issuer 108 may be a limited amount of paystub information contained within the paystub information database, thereby increasing privacy of the ATM cardholder's 202 paystub information from unauthorized users of the presented ATM card. The payment card network 106 transmits the paystub information to the ATM operator 104 (illustrated as 326). The ATM operator 104 thereby transmits the paystub information to the ATM 102 (illustrated as 328), which transmits the paystub information to the ATM cardholder 202 (illustrated as 330). The payroll information generated by the ATM 102 may be in the form of a ATM receipt having payroll information printed thereon. The payroll information presented to the ATM cardholder 202 may be limited to specifically requested paystub information. This allows for not all paystub information to be displayed, thereby increasing privacy of the paystub information from unauthorized users.

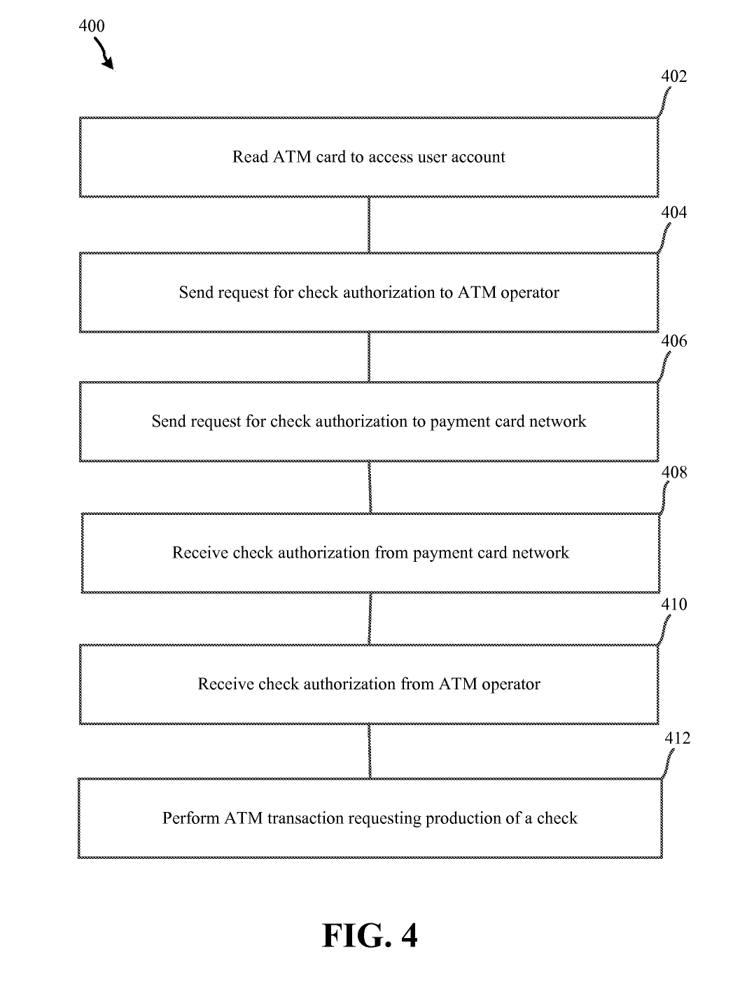

FIG. 4 illustrates a method 400 for generating a check from an ATM according to the present disclosure. At block 402 an ATM reads an ATM card to access a user account. At block 404 a request for a check authorization is sent to an ATM operator. At block 406 the request for the check authorization is sent to a payment card network, that is coupled to card issuers. The request includes a request to one of the card issuers for the check authorization. At block 408 the check authorization is received from the payment card network. At block 410 the check authorization is received from the ATM operator. At block 412 an ATM transaction requesting production of a check is performed.

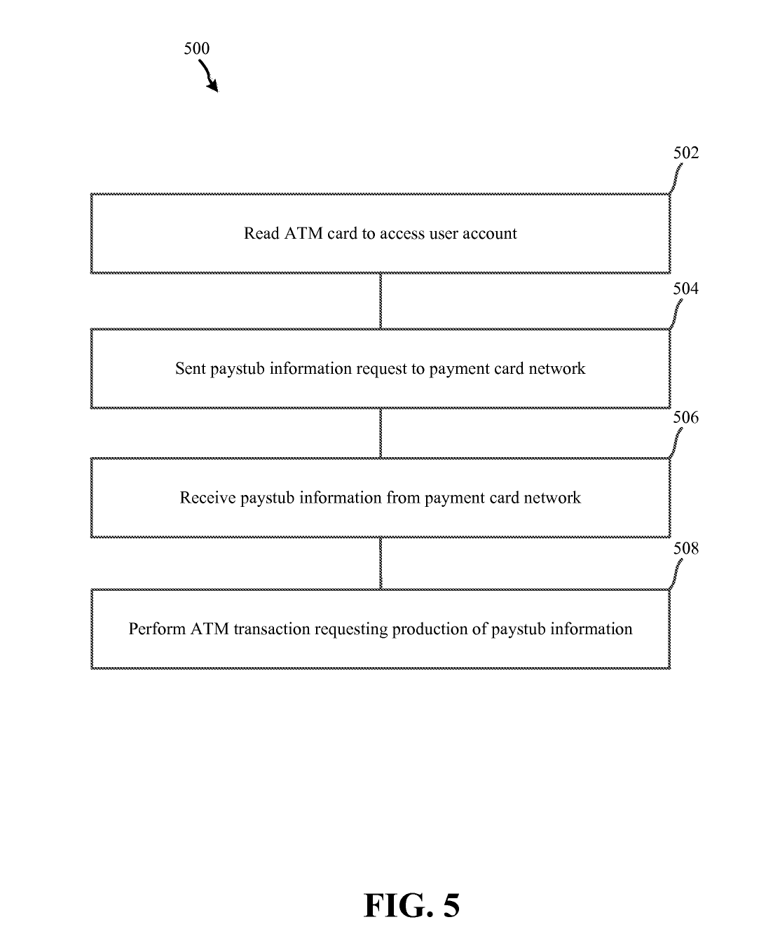

FIG. 5 illustrates a method 500 for generating paystub information from an ATM according to the present disclosure. At block 502 an ATM card is read to access a user account. At block 504 a request is sent to a payment card network. The payment card network is coupled to card issuers and the card issuers are coupled to employer payroll computers. The request includes a request to one of the employer payroll computers for paystub information. At block 506 the paystub information is received from the payment card network. At block 508 an ATM transaction requesting production of the paystub information is performed.

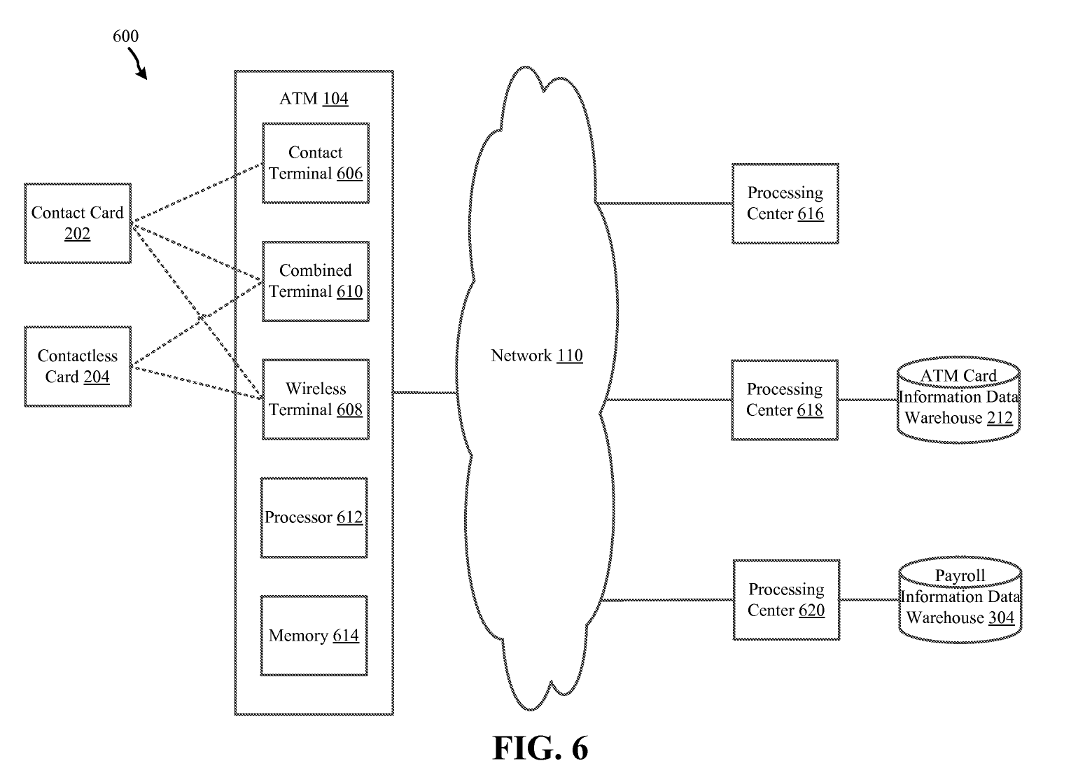

FIG. 6 details a system 600 for providing checks and payroll data from an ATM. The system 600 may include one or more different types of payment devices, for example contact and/or contactless cards 602, 604, used to facilitate transactions by a user with a terminal of the ATM 104, such as the contact, wireless, or combined terminals 606, 608, 610 described in detail hereafter. The contact card 602 may be a device that interacts with transaction terminals using physical communication. Thus, the contact card 602 may have a magnetic stripe. The contactless card 604 may be a device that interacts with transaction terminals without physical communication. Thus, the contactless card 604 may have an antenna that provides for contactless communication, such as by using radio frequency (RF) electromagnetic waves, for example. Each of the cards 602, 604 may contain an integrated circuit (“IC”) chip having a processor portion and a memory portion. The ICs may also include one or more of control logic, a timer, and input/output ports. Such elements are well known in the IC art and are not separately illustrated. One or both of the ICs may also include a co-processor, again, well-known and not separately illustrated. The control logic may provide, in conjunction with the processing portion, the control necessary to handle communications between the memory portion and the input/output ports. The timer may provide a timing reference signal from the processing portion and the control logic. The co-processor may provide the ability to perform complex computations in real time, such as those required by cryptographic algorithms.

The memory portions of both the cards 602, 604 may include different types of memory, such as volatile and non-volatile/flash memory and read-only and programmable memory. The memory portions may store the operating system of the cards 602, 604. The operating system loads and executes applications and provides file management or other basic device services to the applications. The operating system may be stored in read-only memory (“ROM”) within the memory portion.

In addition to the basic services provided by the operating system, the memory portions may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that, strictly speaking, the EMV specification defines the behavior of a terminal; however, the card may be configured to conform to such EMV-compliant terminal behavior and in this sense is itself EMV-compliant. It will be appreciated that applications may be configured in a variety of different ways.

The contact terminal 606 may interface with the contact card 602 through means such as a magnetic stripe terminal. The wireless terminal 608 may interface with both the contact and contactless cards 602, 604. The combined terminal 610 may interface with both the contact card 602 as well as the contactless card 604. In operation, the contact card 602 may be swiped on the contact terminal 606, or may be touched or tapped on the wireless or combined terminals 608, 610, which then contactlessly transmits the electronic data to the proximity IC chip in the contact card 202. Thus, the above-described cards 602, 604 may be ISO 7816-compliant contact cards or devices or NFC (Near Field Communications) or ISO 14443-compliant proximity cards or devices.

The terminals 606, 608, 610 may function via hardware techniques in a processor 612, which is similar to the previously described processors 202, 306, or by program instructions stored in a memory 614.

One or more processing centers 616, 618, 620 (indicative of the payment card network 106, the ATM readable card issuer 108, and the payroll card issuer 302 respectively) may be connected to the ATM 104 via the network 110. The network 110 may include, for example, the Internet, or a proprietary network. Moreover, more than one network 110 may be employed to connect different elements of the system 600.

The processing center 618, which is indicative of the ATM readable card issuer 108, may be in communication with the ATM card information data warehouse 212, which may contain ATM readable card information including, for example, card user, card issuer, card type, and balance of card/user account. The processing center 620, which is indicative of the payroll card issuer 302, may be in communication with a database such as the payroll information data warehouse 304, which may contain various payroll information, such as gross income, net income, and withholding amounts, for example. The processing centers 616, 618, 620 may be operably connected in order to share information. For example, the processing centers 616, 618 and the processing centers 616, 620 may be connected to allow the interchange of information between the data warehouses 212, 304 and the ATM 104.

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art. Like numbers refer to like elements throughout. As used herein, the term “and/or” includes any and all combinations of one or more of the associated listed items and may be abbreviated as “/”.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used in this specification, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It will be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teaching of the present disclosure.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although aspects of the present disclosure are described in terms of various types of payment cards and payment card accounts, it should be understood that the disclosure is not limited to physical cards or accounts associated with physical cards. For example, various payment devices, such as smart phones, tablet computers, and other wireless devices may be used in place of a payment card within the scope of the present disclosure. It should be understood that any such payment device can be used in the same way as a payment card according to aspects of the present disclosure.

Although the present disclosure has been described in connection with the embodiments of the present disclosure illustrated in the accompanying drawings, it is not limited thereto. The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Although specific components have been set forth, it will be appreciated by those skilled in the art that not all of the disclosed components are required to practice the disclosed configurations. Moreover, certain well known components have not be described, to maintain focus on the disclosure.

For firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disc storage, magnetic disk storage or other magnetic storage devices, or other medium that can be used to store desired program code in the form of instructions or data structures and that can be accessed by a computer. Disk and disc, as used herein, includes compact disc (CD), laser disc, optical disc, digital versatile disc (DVD), floppy disk, and blu-ray disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative or instructions and data. The instructions and data are configured to cause one or more processors to implement the functions outlined in the claims.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps presently existing or later to be developed that perform substantially the same functions or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A method for generating a check from an ATM comprising the steps of:
reading an ATM card to identify an account of a user;
receiving a check request from the user, the check request including a check amount;
transmitting a request order for the check to a payment card network, the payment card network being coupled to an ATM card issuer;
receiving a confirmation from the payment card network that the check request was authorized by the ATM card issuer in response to the request; and
printing a check for the requested amount.

2. The method of claim 1 wherein the account is a prepaid card account.

3. The method of claim 1 wherein the check request includes entity information pertaining to an entity to receive the check.

4. The method of claim 1 wherein the check includes a routing number of the ATM card issuer.

5. The method of claim 1 wherein neither the payment card network nor the plurality of ATM readable card issuers own or operate the ATM.

6. A method for distributing payroll data from an ATM comprising the steps of:
reading an ATM readable payroll card to access a payroll account of the user;
receiving a payroll data request from the user;
transmitting the payroll data request to a payment card network, the payment card network coupled to a plurality of ATM readable payroll card issuers;
receiving payroll data from the payment card network; and
printing a paystub containing the payroll data.

7. The method of claim 6 wherein the payroll data request includes a date upon which the payroll data became available to the user.

8. The method of claim 6 wherein the payroll data includes at least one of gross income, net income, or withholdings.

9. The method of claim 7 further comprising the step of:
determining whether the date associated with the payroll data request equals a date of the payroll data received from the payment card network.

10. The method of claim 6 wherein neither the payment card network nor the plurality of ATM readable payroll card issuers own or operate the ATM.

11. An EFT system comprising:
an employer payroll computer;
an ATM card issuer computer coupled to the employer payroll computer and configured to store payroll card account data;
a payment card network computer coupled to the ATM card issuer computer;
an ATM card network computer coupled to the payment card network computer;
an ATM coupled to the ATM network computer;
the employer payroll computer configured to transmit payroll data directly to the ATM card issuer computer;
the ATM issuer computer configured to transmit the payroll data to the ATM via the payment card network computer and the ATM network computer; and
the ATM configured to print a paystub including the payroll data.

12. An ATM for generating a check or payroll data comprising:
a memory;
at least one processor operatively coupled to the memory; and
a persistent storage device operatively coupled to the memory and storing in a non-transitory manner instructions that when loaded into the memory cause the at least one processor to be operative to:
read an ATM card to identify an account of a user;
receive verification information from a user;
receive a request to perform a transaction from the user, the request being one of a check request or a payroll data request;
transmit one of a debit order or the payroll data request to a payment card network computer, the payment card network computer being coupled to an ATM card issuer computer;
receive one of an account deduction confirmation or requested payroll data; and
provide the user with one of a check or payroll data.

13. The ATM of claim 12 wherein the check request includes a check amount and information pertaining to an entity to receive the check.

14. The ATM of claim 12 wherein the check is a check.

15. The ATM of claim 12 wherein the check is a money order.

16. The ATM of claim 12 wherein the ATM readable card is a payroll card.

17. The ATM of claim 12 wherein the payroll data request includes a date upon which payroll data became available to the user.

18. The ATM of claim 12 wherein the payroll data includes gross income, net income, and withholdings.

19. The ATM of claim 12 wherein the at least one processor is further operative to determine whether an amount of the account deduction confirmation equals an amount of the check request.

20. The ATM of claim 12 wherein the at least one processor is further operative to determine whether a date affiliated with payroll data of the payroll data request equals a date affiliated with the requested payroll data.

21. The ATM of claim 12 wherein verification information includes a personal identification number.

22. A method for performing an ATM transaction comprising the steps of:
reading an ATM card by an ATM to access a user account;
sending a request by the ATM to a payment card network, the payment card network being coupled to a plurality of card issuers, and the request including a request to one of the card issuers for a check authorization;
receiving the check authorization from the payment card network by the ATM; and
performing an ATM transaction requested by a user, the ATM transaction including producing a check.

23. The method of claim 22 further comprising the step of:
sending the request to an ATM operator.

24. The method of claim 23 further comprising the step of:
receiving the authorization for the check from the ATM operator by the ATM.

25. A method for performing an ATM transaction comprising the steps of:
reading an ATM card by an ATM to access a user account;
sending a request by the ATM to a payment card network, the payment card network being coupled to a plurality of card issuers, the plurality of card issuers being coupled to a plurality of employer payroll computers, and the request including a request to one of the employer payroll computers for paystub information;
receiving the paystub information from the payment card network by the ATM; and
performing an ATM transaction requested by a user, the ATM transaction including producing the paystub information.

26. A system for performing an ATM transaction comprising:
an ATM operator coupled to an ATM;
a payment card network coupled to the ATM operator;
an ATM card issuer coupled to the payment card network;
an employer payroll computer coupled to the ATM card issuer, the employer payroll computer comprising at least one processor and at least one data storage apparatus;
a paystub database stored in the at least one data storage apparatus, the paystub database containing paystub information specific to an ATM user;
the ATM operator being configured to:
receive a paystub request from the ATM, the paystub request indicating a timeframe of requested paystub information;
receive the paystub information from the payment card network;
determine whether the received paystub information matches the timeframe of the paystub request; and
when the received paystub information is determined to be from a correct timeframe, transmit the paystub information to the ATM.

27. The system of claim 26 wherein the paystub request includes at least one of gross income, net income, and withholding amount.

28. The system of claim 26 wherein the employer payroll computer accesses the paystub database in response to receiving the paystub request from the ATM card issuer.

29. A system for performing an ATM transaction comprising:
an ATM operator coupled to an ATM;
a payment card network coupled to the ATM operator;
an ATM card issuer coupled to the payment card network, the ATM card issuer comprising at least one processor and at least one data storage apparatus;
an ATM account database stored in the at least one data storage apparatus, the ATM account database containing account information specific to an ATM user;
the ATM operator being configured to:
receive a check request from the ATM, the check request including a check amount requested by the ATM user;
receive a draft authorization from the payment card network;
determine whether a draft authorization amount matches the amount of the check request; and
when the draft authorization amount is determined to be correct, transmit the draft authorization to the ATM.

30. The system of claim 29 wherein the draft authorization includes a routing number and a bank account number.

31. The system of claim 29 wherein the draft authorization includes a serial number.
